(19) United States
(12) Patent Application Publication
(10) Pub. No.: US 2002/0099572 A1
(43) Pub. Date: Jul. 25, 2002

(54) Communication system for delivering sterilization test results to customers

(76) Inventors: John D. Dyckman, Commack, NY (US); Jeffrey R. Gardner, Brooklyn, NY (US); Robert R. Jenks, New York, NY (US)

Correspondence Address: OSTROLENK FABER GERB & SOFFEN, 1180 AVENUE OF THE AMERICAS, NEW YORK, NY, 100368403

(21) Appl. No.: 09/961,765

(22) Filed: Sep. 24, 2001

Related U.S. Application Data
(60) Provisional application No. 60/235,532, filed on Sep. 26, 2000.

(51) Int. Cl. G06F 17/60

(52) U.S. Cl. 705/3

(57) ABSTRACT

A communication system includes a central unit, at least one customer unit and a communication link between the central and customer units. The central unit is provided with a server computer operative to have a first mode of communication, wherein sterilizer test results are provided during communication initiated by the one customer unit, and a second mode of communication, wherein the sterilizer test results are provided during communication initiated by the central unit.

### CROSS REFERENCE TO RELATED APPLICATIONS

This application claims the benefit and priority of U.S. Provisional Application No. 60/235,532 filed Sep. 26, 2000 and entitled “Method and Apparatus for Reporting Physician Office Sterilizer Results via the Internet”, the disclosure which is incorporated herein by reference.

### FIELD OF THE INVENTION

The present invention relates to a communication system for delivering sterilization test results to a customer, and more particularly, to a communication system for electronically managing, storing and distributing information related to the sterilization test results between a test conducting facility and a customer.

### BACKGROUND OF THE INVENTION

Sterilization equipment in hospitals, private medical offices and other health care and research facilities needs to be periodically tested to ensure the sterilization procedure is efficacious.

In accordance with one of known sterilization methods, medical equipment is introduced in an autoclave where sterilization steam permeates the equipment, as disclosed in U.S. Pat. No. 5,345,971 which is fully incorporated herein. The test is conducted by placing commercially available preparation bacteria spores in test pack in a sterilizer along with a routine load to be sterilized. Following the sterilization cycle spore strips are sent to a laboratory whose testing equipment determines whether there is any culture growth. If not, the sterilization was effective. Otherwise, the sterilization failed.

Sterilization test results of contaminated medical instruments are important for both patients and medical personnel such as doctors, dentists, veterinarians, research facilities and others who may have an analogous interest in quality of their sterilization equipment. Poorly sterilized equipment may negatively affect a variety of standard medical procedures leading to misdiagnosis, infection and other conditions detrimental to the patient. In addition, inadequately sterilized medical equipment may expose medical personnel responsible for such equipment to lawsuits.

Accordingly, early detection of malfunctioning sterilization equipment is critical to prevent such damage. The culturing period varies and can be as long as one week during which a professional medical office continues to use its sterilization equipment. Typically, a report indicating the test results is then written and mailed to a customer. Overall, the customer may receive the sterilizer test results two to three weeks after the spore strips were shipped to the laboratory.

However, many foreseeable and unforeseeable contingencies can delay the report delivery process for unreasonable periods of time. Reports are often lost in the mail or forwarded to wrong addresses. Many of the customers who receive a report can simply lose it. Restoration of the lost report takes additional time and effort on part of the customers and the laboratory that had issued the lost report.

Those customers who inquire about the sterilizer test results before receiving them via mail and those who want to confirm the lost results typically communicate with a laboratory using facsimile machines and/or telephones. Such communication necessitates the presence of at least two persons: a customer who requests the information and a lab representative who provides this requested information. Even if the laboratory is equipped with an internal computerized system capable of electronically managing the sterilizer test results, it still takes time to identify a caller and retrieve the test results associated with this caller. In other words, a mode of communication between customers and laboratory, which is presently widely used, is time consuming, inconvenient and cumbersome.

What is desired, therefore, is a system for accelerating the availability of the sterilizer test results to a customer and for facilitating the customer's access to these test results. An improved system for timely communication between a laboratory and customers requesting the sterilizer test results is also desirable.

### SUMMARY OF THE INVENTION

It is an object of the present invention to provide a system for improving the speed of delivery of sterilizer test results to a customer.

Another object of the invention is to provide a system of the above character for providing customers of a testing laboratory with opportunity to obtain sterilizer test results through an Internet website.

Still another object of the invention is to provide a system of the above character for electronically registering a customer with a laboratory performing sterilization tests.

A further object of the invention is to provide a system of the above character for retrieving stored sterilizer test results in response to the positive identification of the unique customer identifier.

Another object of the invention is to provide a communication system operating in an interactive mode in which a customer initiates communication with a server unit that delivers sterilizer test results in response to the customer's request.

A further object of the invention is to provide a communication system operating in an interactive mode for selectively using different electronic media to provide a customer with sterilizer test results.

Yet another aspect of the invention is to provide a communication system operating in an automatic mode in which the communication system automatically initiates contact with a customer after sterilizer test results have become available.

Yet a further object of the invention is to provide a centralized communication system for obtaining information which relates to sterilizer test results conducted by multiple testing laboratories and for storing the obtained information to provide customers of multiple laboratories with access to the obtained information.

These and other objects are attained by a communication system including a computerized server unit, which is associated with a facility or laboratory performing sterilization tests, a customer communication device and a communication link for exchanging information between the server unit and the customer communication device.

In accordance with one aspect of the invention, a communication system associated with a testing laboratory is operative to electronically receive, categorize and store miscellaneous information relating to multiple customers via a communication link. The system is operative to assign a unique identifier to a registered customer and store and retrieve information in accordance with the assigned customer's identifier.

Preferably, a communication system in accordance with the invention provides communication between a testing laboratory, which tests the spore cultures for sterilizing efficacy, and customers of the laboratory through the Internet.

According to another aspect of the invention, a communication system associated with a testing laboratory is operative to register multiple customers via a communication link and automatically initiate communication with the registered customers after sterilizer test results have become available. The communication system is capable of contacting the registered customers using a variety of communication modes, which have been specified by customers during a registration procedure.

According to still another aspect of the invention, a centralized communication system is operative to automatically register multiple testing laboratories to obtain and store sterilizer results performed by each of the registered laboratories. The system can provide controllable access to the stored results by customers of the registered laboratories after these customers have been positively identified.

### Other features and advantages of the present invention will become apparent from the following description of the invention which refers to the accompanying drawings.

### BRIEF DESCRIPTION OF THE DRAWINGS

FIG. 1 is a schematic overview of a communication system for providing communication between a testing laboratory and a customer.

FIG. 2 is a flow chart illustrating an operation of an interactive mode of the communication system in which a customer initiates communication with a server unit in accordance with the invention.

FIG. 3 is a flow chart of a registration procedure of the communication system operating in the interactive mode.

FIG. 4 is a flow chart illustrating a customer authentication procedure.

FIG. 5 is a flow chart illustrating a test result retrieval procedure in the interactive mode of operation of the communication system.

FIG. 6 is a flow chart illustrating different test result delivery methods during the interactive mode of communication.

FIG. 7 is a schematic overview of an automatic mode of the communication system in accordance with the invention in which a server unit initiates communication with a customer.

FIG. 8 is a flow chart illustrating a post-registration procedure allowing a registered customer to modify delivery methods and destinations in accordance with the automatic mode of the communication system of FIG. 7.

### DETAILED DESCRIPTION OF THE INVENTION

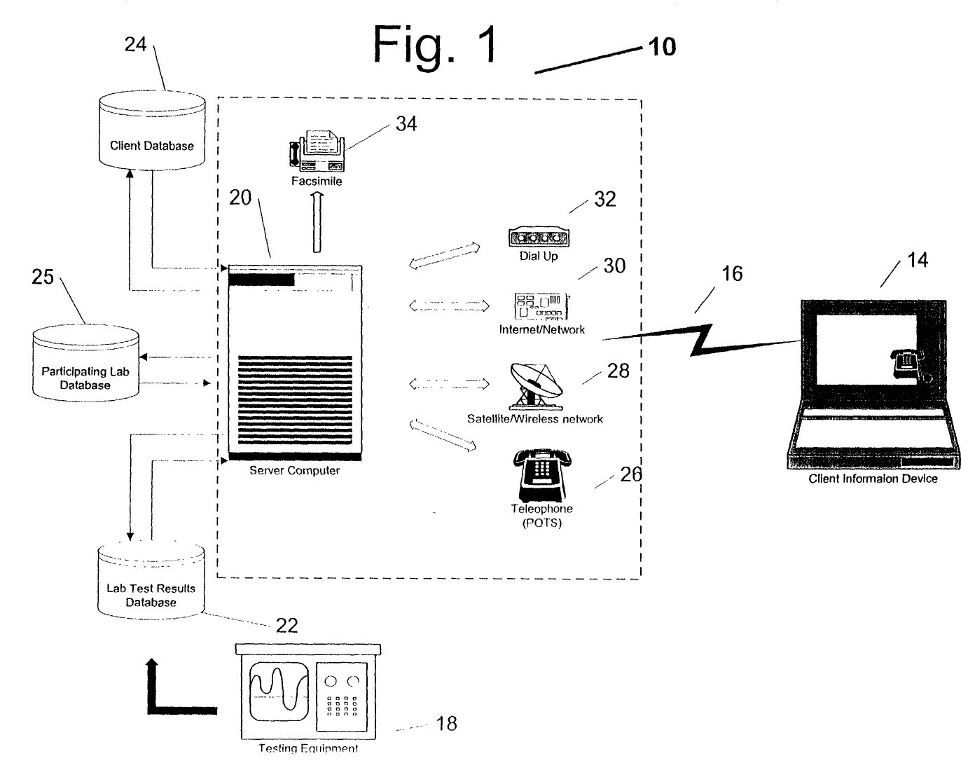

Referring to FIG. 1, an interactive communication system 10 provides a customer using a customer information device 14 with the opportunity of obtaining the sterilization test results from a testing laboratory 12. The communication system 10 includes a platform for conducting real-time, reporting of the sterilization results to the customer using a communication link 16, which is preferably the global computer network known as the Internet.

The communication link can be any electronic media allowing for the electronic exchange of information between the customer and the server computer and may include in addition to the Internet, private and public data networks 30, as well as a wireless network 28, analog telephone 26 and facsimile 34 systems. The wireless network may include satellite communication, Sprint PCS, GSM, pager systems, and combinations of these.

The physical elements for carrying out the inventive system are known and include functional and structural components linking the customer information devices with a host or server computer 20. Customer information device 14 is any electronic device operative to enable a customer to exchange information with the computer through the communication link 16. In particular, the customer information device may include a PC, laptop, PDA-palm pilot in combination with an auxiliary communication device including a facsimile machine, cell phone, and traditional telephone system (POTS).

The server computer hosts a web site, a collection of text and image data and executable program data, which are accessible through the Internet. Data is stored in a storage device which may include one common, but preferably, separate lab result and client databases 22 and 24, respectively. The web site has a conventional Internet address (URL) which permits customers accessing the Internet to locate the web site and view and/or execute programs associated therewith.

Generally the invention provides a customer, selected among entities that may be interested in the quality of sterilization of their equipment, with access to test results outputted by testing equipment 18 in accordance with the method disclosed, for example, in U.S. Pat. No. 5,345,971. The test results are stored in the lab result database 22 and thus become available to the customer contacting the laboratory through the communication link 16.

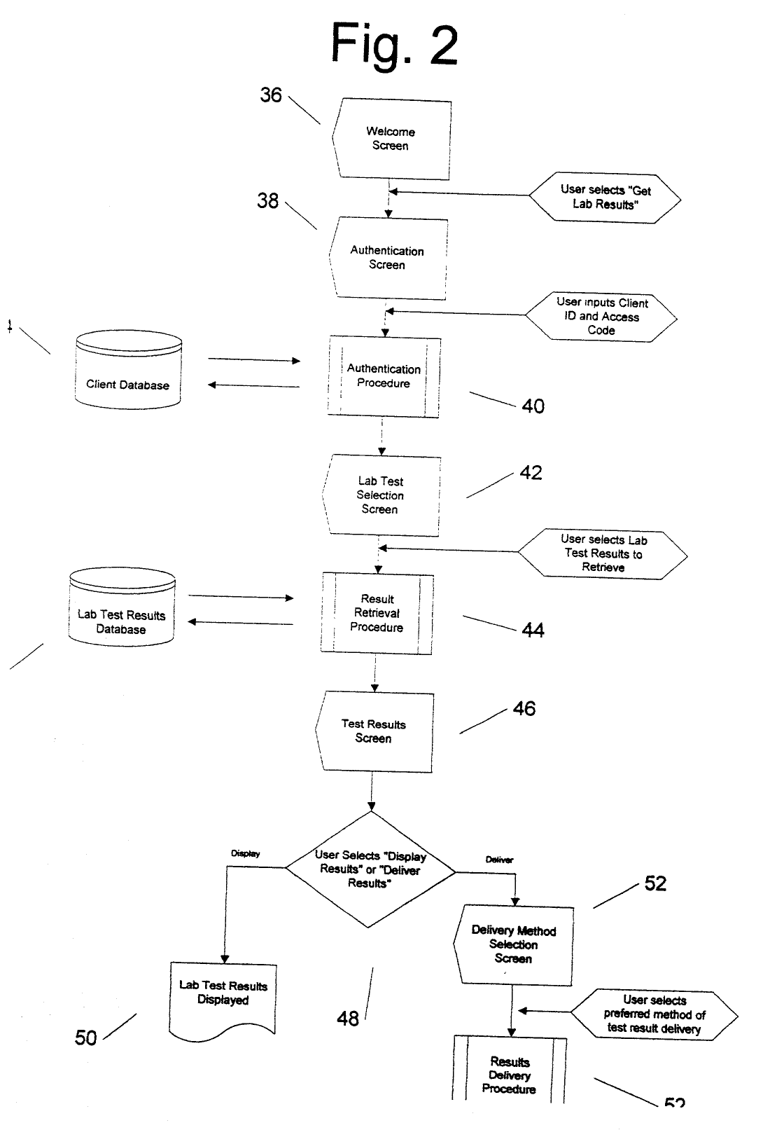

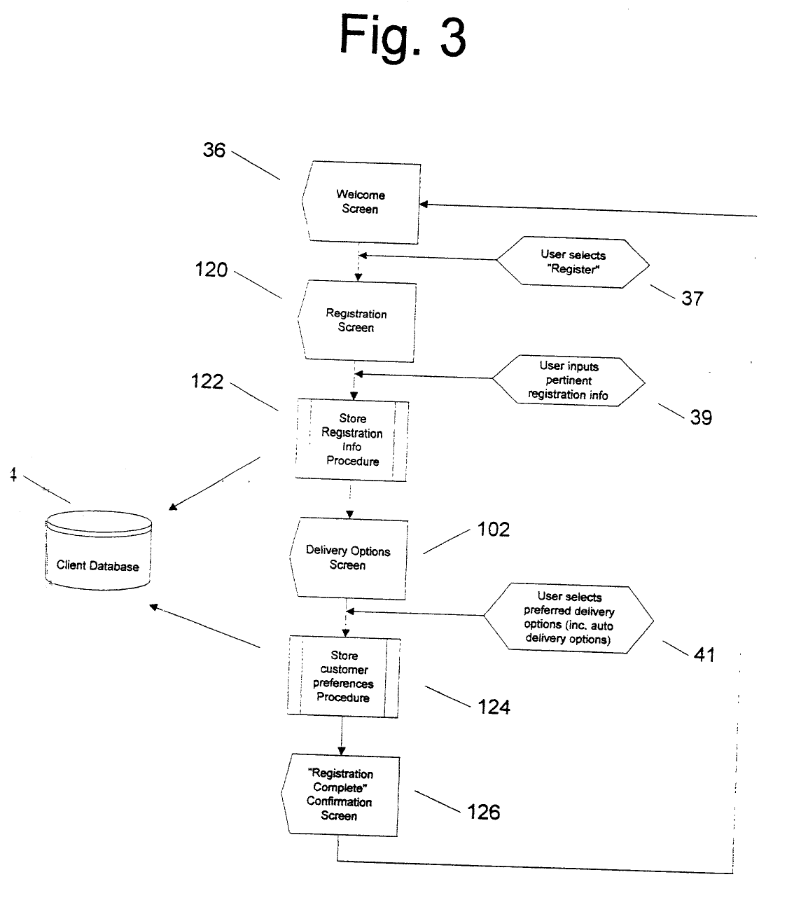

Referring to FIG. 2, using a browser, such as Netscape Navigator or Microsoft Internet Explorer, a customer accesses the web site of the host computer 20 having a welcome screen 36, which inquires of the status of the customer. If a logged-in unregistered user wants to register to become a customer, the server computer 20 initiates a registration procedure as illustrated in FIG. 3.

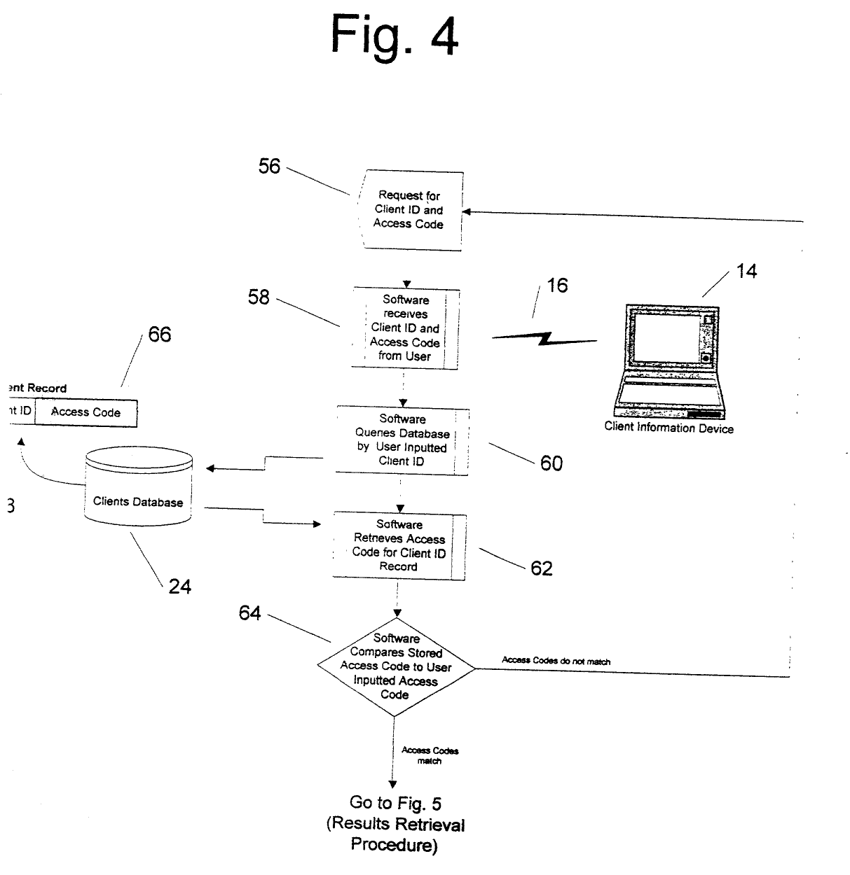

To accomplish the registration, software executing on the server computer 20 directs a customer to a registration screen 120, where the customer is able to fill out a registration form at 37. A variety of designs of such a registration form can be easily implemented, and typically this form may include the customer's name, address, telephone number, social security number and the like, as generally indicated at 39. Any of the items on this form can be further used as a unique client identifier or ID 68 (FIG. 4) identifying a customer during subsequent sessions. The client ID can be either selected by the customer or assigned by the server computer during the registration procedure. In addition to the client ID, the customer may have an access code 66 (FIG. 4) for the purposes of the customer's authentication, as will be disclosed in detail with reference to FIG. 4.

The information inputted by the customer can be verified in real time by using any standard methods including an electronic mechanism allowing for the electronic exchange of information between the server computer and various sources capable of verifying the inputted information. For example, if a credit card number is required for further automatic billing, the customer's information can be checked with the bank that issued this credit card. Alternatively or in addition to the electronic verification of the inputted information, it is possible to provide manual verification, offline. After the verification procedure, the inputted information is stored at 122 in FIG. 3 and loaded in the client database 24.

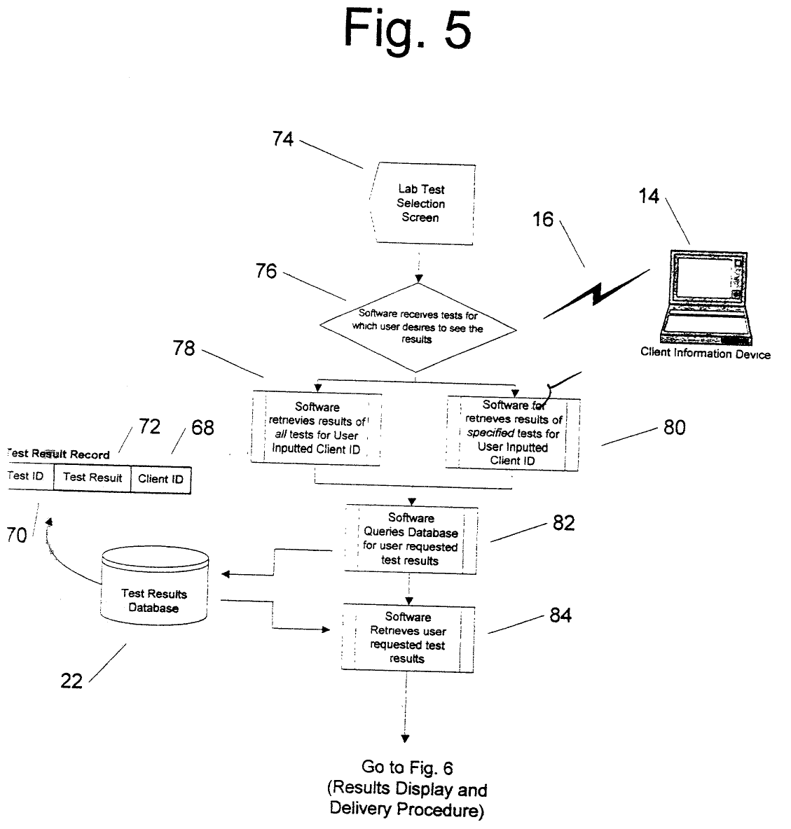

During the registration procedure, the customer may select at least one delivery method offered at 41 and stored at 124, as will be explained in detail with reference to FIG. 5. Finally, the customer may view the inputted information at a confirmation screen 126, after which the registered customer is directed back to the welcome screen 36.

Referring to FIGS. 2 and 4, illustrating the authentication procedure of a registered customer, each customer is required at 56 to input the client ID 68 allocated to the customer during the registration procedure as discussed above. Since the information sought by the customer is confidential, in addition to the client ID, the customer may have a unique access code 66 based on which the customer can be authenticated by the server computer. The access code includes any input data that provides a customer with access to test results and can include numerous alphanumeric codes, such as passwords, designating keys and the like. Alternatively or in addition to these alphanumeric codes, a different type of personal data, for instance, customer's biometric data including fingerprint information, a voice pattern and the like can serve as an access code. A variety of photo-electrical sensors (not shown) interfacing with the customer information device 14 can be used to detect unique biological patterns of the customer. Sensors for entering biometric data can be incorporated in a keyboard of the customer device 14 or designed as a separate part. In response to entering a client ID and/or access code at 58 by a customer, software executing on the server computer 20 queries the client database 24 at 60 and first identifies a customer in response to the inputted client ID and further retrieves the stored customer data at 62 associated with the client ID code. To authenticate the customer, the server computer is operative to correlate the retrieved data with the inputted access code. If the client's access code is not positively matched with the stored data, the customer is directed to 56 to repeat the entire authentication procedure. After positive authentication, the customer is allowed to view the test results and transfer them on the customer information device 14.

Password-only authentication can be cumbersome because a password's viability is enhanced, among other ways, by increasing its length. Further, passwords can be forgotten, lost, stolen or otherwise compromised. In this regard, authentication can be made based only on comparing the inputted biometric data with the stored biometric data. Furthermore, the use of biometric data can eliminate a need in an ID code, since the inputted biometric data can be compared with all data stored in the client database 24 in short time. Thus, a method of authentication varies depending on the number of customers, type of equipment and particular needs experienced by a test conducting facility.

After being positively authenticated, a customer is enabled to access the test results stored in the rest result database 22, in accordance with the procedure illustrated in FIGS. 2 and 5. Assuming that the customer is a long-term client, the test result database may contain the results of multiple tests performed for the customer in the past. The customer using a lab test selection screen 74 can obtain test results at 76 of the last test by means of software executing on the server computer 20. If the customer needs to obtain the results of previous tests, the test selection screen 74 allows the customer to specify a desired period of time and/or a number of tests. Accordingly, as shown at 78 and 80, the customer may select, for example, all of the previously performed tests, last five tests or a specific test associated with a specific time period.

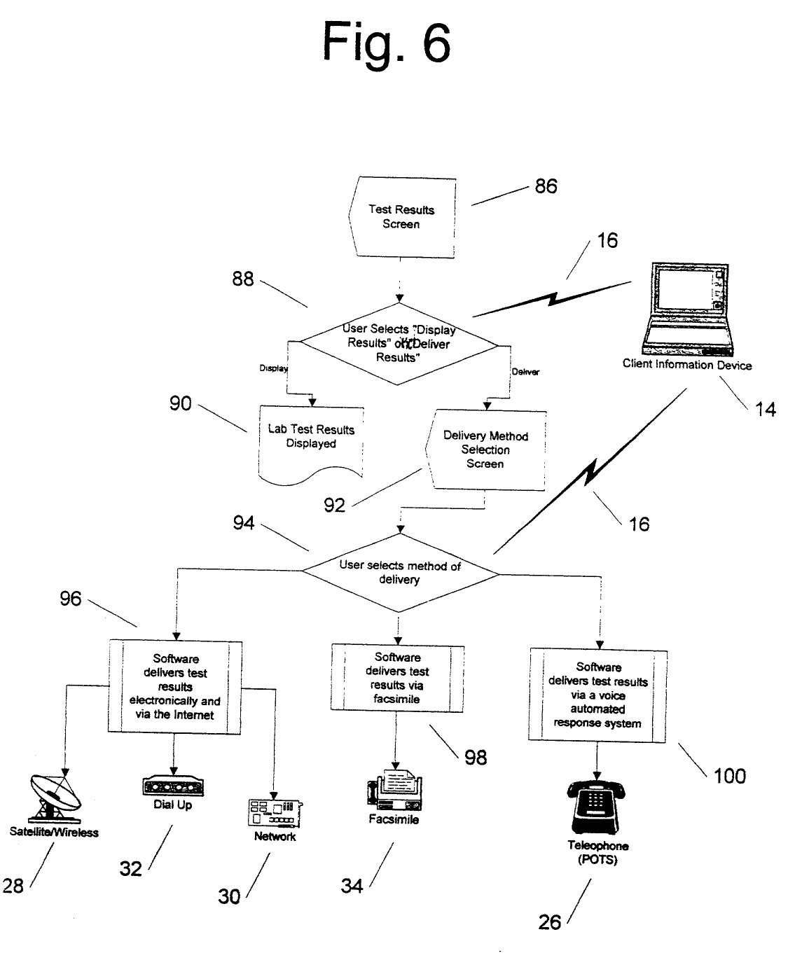

In response to the selection of a particular test or tests, software executed on the server computer 20 queries the test result database at 82 to identify the results of the selected tests each of which has been internally assigned a respective test ID 70. The test results are retrieved at 84, and the customer can view them at 90 (FIG. 6). Also, the server computer may forward the test results to the customer information device 14 in accordance with the preferred delivery method selected during the registration procedure.

Specifically, a logged-in user, for example, an authorized employee of the customer, may wish to forward the test results directly to the employee's supervisor, such as a physician or dentist. Software executing on the server computer allows the logged-in customer to have the tests results displayed and in addition forwarded to a predetermined destination at 88, as stored in the client database during the registration procedure. In addition to the already stored delivery method, the logged-in-customer may specify on demand an alternative destination to which the server computer is operative to forward the test results at 92.

The server computer is operative to deliver the test results to the predetermined destination via the Internet and in addition via other specified electronic media. As a result, the test results can be forwarded to a registered cell phone 28, “pagers”/text message devices 28 and facsimiles 34 via the Internet at 96 and 98, respectively. In addition to electronic data communication, software 100 enables the server computer 20 to communicate with the customer via a traditional telephone network (POTS) to receive and interpret voice commands and to transmit voice messages.

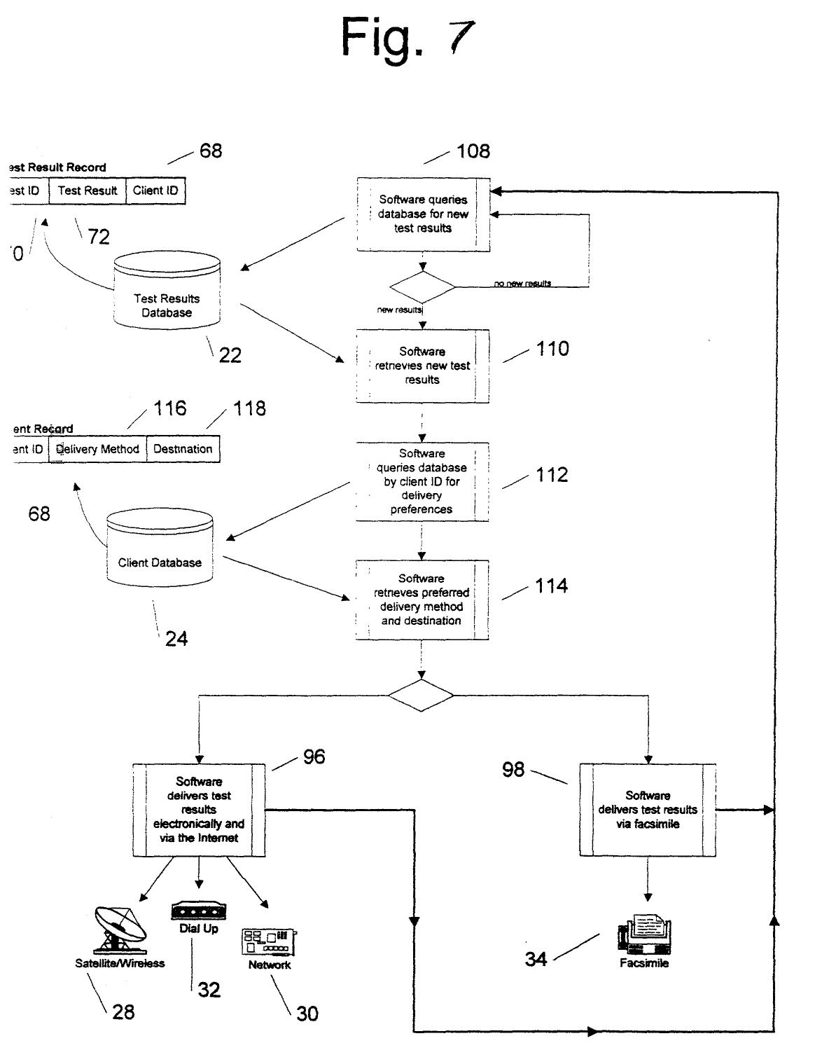

In accordance with another aspect of the invention shown in FIG. 7, the communication system 10 can work in an automatic mode of communication. Using this mode, the server computer initiates communication with a customer and delivers the test result without customer interaction.

To implement this mode, software executing on the server computer queries at 108 the test results database 22 for new tests results in a predetermined manner. If there are new results at 110, the server computer 20 is operative to retrieve them from the test results database 22. Each test result includes a test ID 70, a test result 72 (i.e. a positive or negative result), and a client ID 68 assigned and stored during the registration procedure.

Further, in response to retrieval of each new test result, the server computer 20 is operative to identify a customer associated with the retrieved client ID. To accomplish it, software executing on the server computer queries at 112 the client database 24 by the previously retrieved client ID 68 and receives client information at 114 including a preferable delivery method and destination at 96 and 98.

Based on the retrieved client information at 114, the server computer is operative to implement the preferable delivery method 116. The destination of such delivery maybe, for example, a phone number, page number, e-mail address, fax number and the like, 28, 30, 32 and 34 as explained with reference to FIG. 6. After delivering all new test results to multiple customers, the server computer restarts the automatic mode by querying at 108 the test results database 22 for new results. Alternatively, the server computer 20 may pause for a specified period of time (not shown) prior to restarting the automatic delivery process.

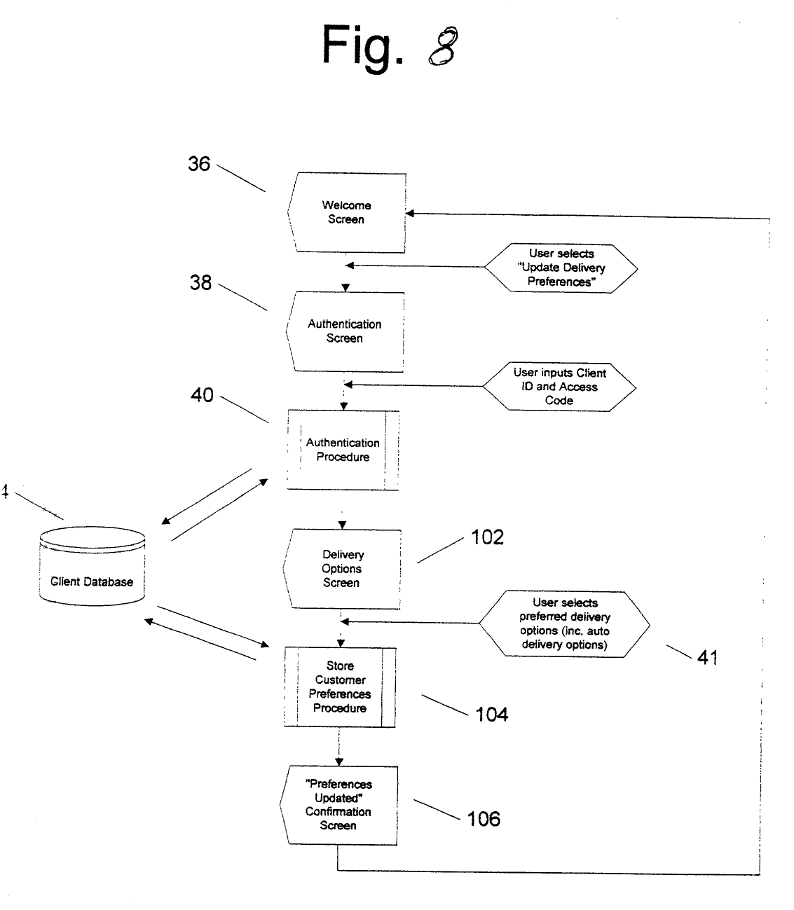

FIG. 8 illustrates a customer's post-registration selection and/or modification of delivery preferences in the automatic mode. A customer may desire to enable or disable the server computer to deliver test results in the automatic mode. In addition, the customer may desire to modify or update the customer's preferred method of delivery as well as the customer's preferred delivery destination. To accomplish it, the customer may access the system at 36 and select update delivery preferences. Software executing on the computer 20 retrieves the customer's existing preferences from the client database 24 and transmits them to the customer at 102, who modifies these preferences as desired. The server computer then executes software for storing the customer's modified preferences in the client database 24 at 104. Finally, the customer receives a “preferences update confirmed” message 106 transmitted by the server computer.

In accordance with still another aspect of the invention, the server computer 20 can initiate communication with the information device 14 after the results have become available, as explained with reference to the automatic mode of communication. However, instead of transferring the retrieved test results on the information device, the server computer leaves a message specifying a predetermined time during which the customer may connect to the central unit. As a result, the customer retrieves the stored results in accordance with the interactive mode of communication. The specified time is assigned in such a manner that the customer does not have to wait a long time after the test results become available. This aspect of the invention allows the server computer 20 to work in a mode most favorable to this computer, such as certain hours of the day when the server computer is not overloaded. At the same time, the security of transferred information offered by the interaction mode of communication and operative delivery of the test results to a customer are not compromised.

An additional aspect of the present invention includes a centralized test results retrieval and delivery system. A centralized system allows participating laboratories to economically and efficiently manage customers and provide them with access to test results. The centralized system can facilitate a participating laboratory's ability to extend their presence to new geographic markets and expand their existing customer base without significant increases in operating costs such as postage, toll-free phone access, and customer representatives and services. The centralized system could also be enabled to manage billing of customers.

Such a system would store the tests results for multiple testing laboratories, regardless of their geographic location. Customers of a participating testing laboratory may automatically receive, retrieve or forward test results. In addition to the client and test results database described in FIG. 1 at 22 and 24, the centralized system would also comprise a participating laboratory database containing pertinent information such as a unique lab identifier.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. A communication system for providing a customer with test results via a communication link, comprising:
a central unit receiving the test results;
at least one customer unit; and
a test database of test results accessible by the central unit, the central unit, the test database and one customer unit being adapted to be coupled by the communication link.

2. The communication system defined in claim 1, wherein the one customer unit has at least one information device operative to send a request inquiring about the test results through the communication link to the central unit.

3. The communication system defined in claim 2, wherein the one information device comprises at least one of a personal computer, laptop, and PDA-palm pilot.

4. The communication system defined in claim 3, wherein the one information device is operative to electronically send the request through the communication link.

5. The communication system defined in claim 1, wherein the one customer unit has an auxiliary communication device in communication with the central unit, the auxiliary communication device being operative to receive the test results transmitted by the central unit in response to the request generated by the one information device through the communication link while the information device is connected to the central unit.

6. The communication system defined in claim 1, wherein the central unit is operative to provide a registration procedure for a first-time customer in response to communication initiated by the one information device and transmitted through the communication link.

7. The communication system defined in claim 1, wherein the central unit includes a server computer operative to assign a client identifier to a registered customer during the registration procedure, the server computer being operative to identify the customer during subsequent communication sessions between the central and customer units in response to inputting the client identifier.

8. The communication system defined in claim 7, wherein the server computer is operative to generate and display a registration form in response to the request, the registration form including a variety of questions related to personal information.

9. The communication system defined in claim 8, wherein the server computer is operative to allocate an authentication access code to the customer, the authentication access code comprising at least one of an alphanumeric code and biometric data.

10. The communication system defined in claim 9, wherein the central unit further includes a client database accessible by the server computer for storing the personal information and the access code of the registered customer.

11. The communication system defined in claim 10, wherein the server computer is operative to query the client database in response to the client identifier, retrieve the stored authentication access code corresponding to the inputted client identifier and correlate the retrieved and inputted authentication access codes to authenticate the customer.

12. The communication system defined in claim 11, wherein the server computer is operative to transfer the retrieved test results to the one information device upon positive correlation between the inputted and stored authentication access codes.

13. The communication system defined in claim 9, wherein the biometric data is selected from the group including a voice pattern, fingerprint, handwriting pattern and combination of theses, the customer unit including at least one sensor being operative to detect the inputted access code and being in communication with the one information device.

14. The communication system defined in claim 6, wherein the server computer is operative to store a delivery method of the test results specified by the customer.

15. The communication system defined in claim 14, wherein the server computer is operative to deliver the test results to the customer unit in accordance with the specified delivery method in response to communication initiated by the customer with the central unit through the communication link.

16. The communication system defined in claim 14, wherein the delivery method includes wireless communication and plain old telephone system.

17. The communication system defined in claim 16, wherein the wireless communication is selected from the group consisting of an e-mail, cellular phone, facsimile and combinations of these all in communication with the server computer and operative to receive the test results.

18. The communication device defined in claim 16, the client database is operative to store an e-mail address and cellular, telephone and facsimile numbers specified by the customer during selection of the method of delivery.

19. The communication system defined in claim 1, wherein the communication link is the Internet.

20. The communication system defined in claim 1, wherein the central unit is operative to initiate communication through the communication link with the one customer unit after the test results have become available and to assign a predetermined time when the customer unit may connect to the server computer to retrieve the test results.

21. The communication system defined in claim 1, wherein the central unit is operative to initiate communication through the communication link after the test results have become available and provide the one customer unit with the test results.

22. The communication system defined in claim 21, wherein the server computer is operative to query the test database in a controlled manner and retrieve new test results, the server computer being operative to assign internally a respective test identifier to each of the test results, the test identifier including the client identifier.

23. The communication system defined in claim 22, wherein the server computer is operative to query the client database by the client identifier and to retrieve the personal information of the customer corresponding to the client identifier.

24. The communication system defined in claim 23, wherein the retrieved personal information includes information relating to a preferred test results delivery method.

25. The communication system defined in claim 24, wherein the server computer is operative to change the delivery method in response to communication initiated by the one information device through the communication link.

26. The communication system defined in claim 21, wherein the server computer is operative to periodically and continuously query the test database.

27. A communication system for providing a customer with test results via a communication link, the test results are performed by test equipment, comprising:
at least one customer unit provided with an information device;
a server computer operative to receive the test results from the test equipment;
a test database of test results and accessible by the server computer, the central unit, the test database and one customer unit being adapted to be coupled by the communication link for transmitting and receiving electronic information related to and containing the test results,
the server computer having a first mode of communication, wherein the server computer is operative to retrieve the test results from the test database in response to connection initiated by the one customer unit, the server computer having a second mode of communication, wherein the server computer is operative to initiate communication with and transmit the test results to the one customer unit after the test results have been stored in the database through the communication link.

28. The communication system defined in claim 27, wherein the communication link is the Internet.

29. The communication system defined in claim 27, further comprising a client database accessible by the server computer.

30. The communication system defined in claim 27, wherein the one customer unit has at least one information device operative to send a request inquiring about the sterilizer test results through the communication link to the server computer in the first mode of communication.

31. The communication system defined in claim 30, wherein the one information device is selected from the group consisting of a personal computer, laptop, PDA-palm pilot and combination of these operative to send the request through the Internet.

32. The communication system defined in claim 27, wherein the one customer unit has an auxiliary communication device in communication with the server computer, the auxiliary communication device being operative to receive the sterilizer test result transmitted by the server computer in response to the request transmitted by the one information device through the communication link in the first mode of communication of the server computer.

33. The communication system defined in claim 28, wherein the server computer is operative to provide a registration procedure for a first-time customer in response to communication initiated by the one information device and transmitted through the communication link.

34. The communication system defined in claim 28, wherein the server computer is operative to allocate a client identifier during the registration procedure.

35. The communication system defined in claim 27, wherein the server computer is operative to allocate an authentication access code to the customer, the authentication access code being selected from the input data group consisting of an alphanumeric code, biometric data and a combination of these.

36. The communication system defined in claim 29, wherein the client database accessible by the server computer is operative to store the personal information in correspondence with the client identifier and the access code.

37. The communication system defined in claim 27, wherein the test database is operative to store the received test results in correspondence with a test identifier assigned internally to the sterilizer test and including the client identifier.

38. The communication system defined in claim 27, wherein the server computer is operative to query the client database in response to receiving the client identifier in the first mode of communication, retrieve the stored authentication access code corresponding to the inputted client identifier and correlate the retrieved and inputted authentication access codes to authenticate the customer.

39. The communication system defined in claim 39, wherein the server computer is operative to transmit the test results on the one information device upon positive correlation between the inputted and stored authentication access codes in the first mode of communication.

40. The communication system defined in claim 35, wherein the biometric data is selected from the group including a voice pattern, fingerprint, handwriting pattern and combination of theses, the customer unit including at least one sensor being operative to detect the inputted access code and being in communication with the one information device.

41. The communication system defined in claim 27, wherein the server computer is operative to store a delivery method of the test results specified by the customer.

42. The communication system defined in claim 41, wherein the server computer is operative to deliver the test results to the customer unit in accordance with the specified delivery method in the first mode of communication.

43. The communication system defined in claim 41, wherein the delivery method includes wireless communication and plain old telephone system.

44. The communication system defined in claim 43, wherein the wireless communication is selected from the group consisting of an e-mail, cellular phone, facsimile and combinations of these all in communication with the server computer and operative to receive the test results.

45. The communication device defined in claim 29, the client database is operative to store an e-mail address and cellular, telephone and facsimile numbers specified by the customer during selection of the method of delivery.

46. The communication system defined in claim 27, wherein the server computer is operative to query the test database in a controlled manner and retrieve new test results in the second mode of communication.

47. The communication system defined in claim 46, wherein the server computer is operative to query the client database by the client identifier which has been retrieved during identification of the test identifier, the server computer being operative to retrieve the personal information of the customer corresponding to the client identifier.

48. The communication system defined in claim 27, wherein the retrieved personal information includes information relating to the preferred method of delivery in the second mode of communication.

49. The communication system defined in claim 27, wherein the server computer is operative to periodically and continuously query the test database in the second mode of communication.

50. A communication system for providing a plurality of customers with test results, comprising:
a central unit receiving the test results;
a plurality of customer units;
a test database of test results accessible by the central unit;
a client database of customers accessible by the central unit; and
a communication link between the central unit and the plurality of customer units for transmitting and receiving electronic information related to and containing the test results, the central unit having a server computer which has a first and second mode of communication, the server computer being operative to query the client database in response to communication initiated by each of the customer units and to retrieve the test results from the test database after a respective customer unit has been authenticated in the first mode of communication, the server computer being operative to automatically retrieve the test results from the test database and to initiate communication with a respective customer unit which has been identified in response to retrieval of the test results in the second mode of communication.
